(19) United States
(12) Patent Application Publication
(10) Pub. No.: US 2024/0046821 A1
(43) Pub. Date: Feb. 8, 2024

(54) Marking Units Disposed on a a Tape Roll

(71) Applicant: Steven Cannon, Chapel Hill, TN (US)

(72) Inventor: Steven Cannon, Chapel Hill, TN (US)

(21) Appl. No.: 17/902,121

(22) Filed: Sep. 2, 2022

Related U.S. Application Data
(63) Continuation of application No. 63/395,648, filed on Aug. 5, 2022.

(51) Int. Cl. G09F 3/02

(52) U.S. Cl. CPC G09F 3/02; G09F 2003/0229; G09F 2003/023; G09F 2003/0266; G09F 2003/0269

(57) ABSTRACT

A roll of similar marking units provides a way to mark direction of flow, issues, etc., by various parties. The marking units have an adhesive surface on one of a first and second portion. The first portion preferably has first and second angled segments extending from opposing sides to a point. The second portion preferably has third and fourth angled segments meeting at an internal corner. Adjacent units preferably contact one another on the roll and are separated along the first and second angled segment when pulling the end unit off of the roll.

### CLAIM OF PRIORITY

This application claims the benefit of U.S. Provisional Patent Application No. 63/395,648 filed Aug. 5, 2022, which is incorporated herein by reference in its entirety.

### FIELD OF THE INVENTION

The present invention relates to arrow or chevron shaped adhesive backed pointers or markers sequentially disposed about a roll providing arrow or marking segments, particularly well adapted to serve as adhesive indicators for various uses and be applied potentially independently of specially designed dispensers.

### BACKGROUND OF THE INVENTION FIELD OF THE INVENTION

U.S. Pat. No. 4,008,682 teaches the construction and use of a tape dispenser that cuts strip tape of a specific width into arrow shapes having points at one end extending away from the tape and corresponding internal points at the other with two opposing triangles at the edges of the tape (the points are at edges). A portion of the tape is then apparently not moistened so that a center strip of the tape segment can relatively easily be handled to apply the tape, while also assisting in the removal of the tape.

Masking tape, and other tape has been provided in roll form for years.

In the construction industry, it is not unusual to employ a pad of sticky notes (rectangles having an adhesive strip toward one edge) to place near imperfections, such as in paint or drywall to identify issues for someone to address or touch up. While sometimes effective, other times, it may be difficult to identify a specific imperfection relative to the rectangular shape of the sticky note in the absence of any other indicia.

The applicant believes that there is a need for improved arrow or chevron shaped indicators for use in various fields.

### SUMMARY OF THE INVENTION

It is an object of many embodiments of the present invention to provide an improved adhesive indictor.

It is another object of many embodiments of the present invention to provide an improved adhesively applied pointer.

It is an object of many embodiments of the present invention to provide a roll of adhesively applied pointers.

It is an object of many embodiments of the present invention to provide a roll of adhesively applied arrow shaped portions having bottoms with at least portions that are adhesive.

Accordingly, the applicant has developed a tape-based product preferably having first and second portions. The first portion has two angled segments extending symmetrically relative to a center of the tape from the edges to an extending point at the center. The first portion also has a first adhesive portion on a bottom surface. A second portion extends from the first portion and has a recess formed of two angled segments extending from the edges, symmetrically toward the center of the tape to meet at an internal corner (which may correspond to the point of the next first portion). First portion may be perforatedly connected to another first portion with a second portion extending above (or below) the adjacent first portion of a second tape based marker or first portion may be connected to an adjacent second portion of a second tape based marker depending upon the particular embodiment selected.

The arrow or chevron marker may be utilized to point at a specific issue that is desired to be addressed, like a paint or drywall imperfection, to identify a direction of fluid flow, or for various other uses to potentially provide information or direct someone's attention to something. Different color tapes may be utilized within certain fields to identify different situations.

As each marker connects to the next, perforations may be utilized to assist in separating one unit from another. Other embodiments may stack successive units onto one another or onto a roll. For at least some embodiments, the second portions of the marker units extend outwardly relative to the roll (away from the last unit's first portion which was just removed from the roll). When the first portions connect to one another, the tails may possibly take on other shapes that do not necessarily appear to nest within adjacent first portions. However, for many embodiments, the second portions provide corners which coincide with the points of adjacent first portions.

There are many different ways that adjacent units may be connected to one another and/or the roll. Some tapes may be constructed so that only first portions have adhesive on the bottom surface and then rolled into a roll. Other embodiments may have adhesive on bottom portions of both first and second portions. Still, some tapes may be formed up of individual marker units, and yet still other methods of making the rolls can be provided as the manufacturer believes to be desirable. When adjacent first portions are connected together, such as separated with perforations, it may be that second portions are connected to the first portions during the rolling process. Portions of adjacent first or second portions could also function as “release paper” for adjacent marker portions for some embodiments.

### BRIEF DESCRIPTION OF THE DRAWINGS

The particular features and advantages of the invention as well as other objects will become apparent from the following description taken in connection with the accompanying drawings in which:

FIG. 1 is top perspective view of a first embodiment of a roll of adjacently disposed marker units;

FIG. 2 is a top plan view of a first marker unit removed from the roll of FIG. 1;

FIG. 3 is a bottom plan view of the first marker unit of FIGS. 1 and 2;

FIG. 4 is a side plan view of the embodiment of FIG. 1 before removing the first marker unit from the roll;

FIG. 5 is a top plan view of a second embodiment of a roll as partially unrolled, but still connected, or a bottom plan view of the first embodiment of FIGS. 1-4;

FIG. 6 is a side plan view of the embodiment of FIG. 6 before removing a first marker unit from the roll;

FIG. 7 is a top perspective view of the embodiments of FIGS. 5-6 showing a first marker unit removed from the others;

FIG. 8 shows a side plan view showing connection of adjacent units with first portions connected at adjacent first or second portions as a third embodiment.

### DETAILED DESCRIPTION OF THE PREFERRED EMBODIMENTS

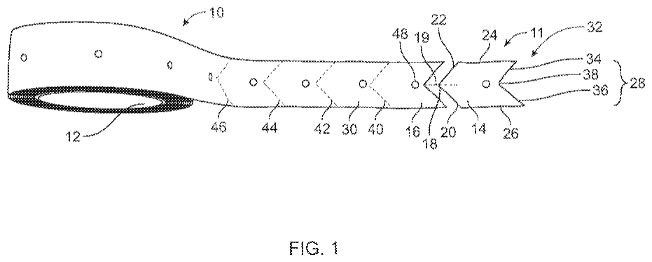

FIG. 1 shows a first embodiment of a tape product 10 having successive tape marker units 14, 16 which can be removed from a roll 12 individually, or in multiples to provide a longer chevron or arrow shape as will be explained in detail below.

Each marker unit 14, 16, etc., may have an extending point 18, such as at center line 19 of tape 30. The point may be the intersection of first and second angled segments 20, 22 which extend from side edges 24, 26 of tape 30 and preferably meet at extending point 18. Between side edges 24, 26 is the width 28 of the tape 30. The first and second angled segments 20, 22 and the point 18 are preferably disposed on a first portion 50 of the marker unit 14.

A second portion 52 of the marker unit 14 preferably extends rearwardly of the first unit and has third and fourth angled segments 34, 35 beginning at edges 24, 26 and meet at an internal corner 38. The internal corner 38 is an angle as are the first and second points 31, 33 at the edges 24, 26. The points 31, 33 are preferably at an end 32.

Perforations 40, 42, 44, 46, and others, may separate one marker unit 14, 16 from one another. For the embodiment of FIG. 1, indicia 48 may be useful to identify where to grasp the marker unit 14, 16. It may be that the indicia is on a second portion 52 which lacks adhesive on second surface 56. Meanwhile first surface 54 on the bottom of the first portion 50, or at least a portion thereof, preferably has an adhesive surface. Second surface 56, or at least a portion thereof, could also have an adhesive surface for at least some embodiments as well.

First and second portions 50, 52 may be similarly shaped for at least some embodiments. Additionally, first and second edge lengths 58, 60 could be different lengths for different embodiments providing a different look. Fifth and sixth angled segments 62, 64 may start at edges 24, 26 and proceed to second internal corner 66 which may delineate a difference between first and second portions 50, 52 for at least some embodiments. Not all of first surface 52 and second surface 56, if adhesive, needs to be completely coated in adhesive for all embodiments.

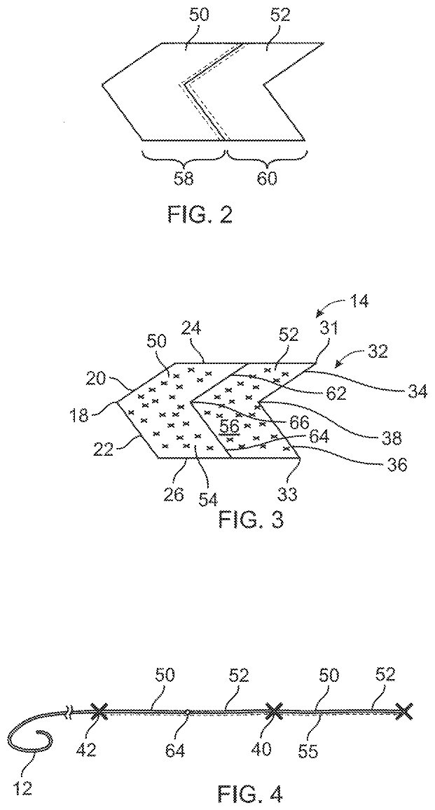

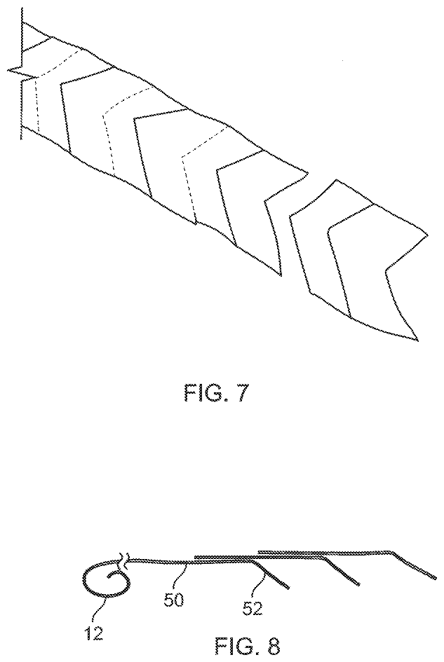

Examining the various embodiments of FIGS. 1-8 will quickly reveal that there are many ways that a roll 12 of tape product 10 may be provided. FIG. 4 shows where perforation separates a second portion 52 from an adjacent first portion 50. One would understand that the point 18 may fit within the corner 38 with first and third angled segments 20, 34 contacting one another at perforation 40 as well as second and fourth angled segments 22, 36. First and second segments 20, 22 may meet at about 90 degrees as could third and fourth segments 34, 36 as illustrated. Of course, other angles could be employed for various embodiments. Also, although two angled segments are utilized as first and second angled segments 20, 22 as well as third and fourth angled segments 34, 36 and fifth and sixth angled segments 62, 62, these segments need not be linear and could be more intricately provided than just straight lines, they could be jagged, curved, be comprised of various smaller segments, etc. depending on the specific shape desired by the manufacturer and/or end user as specified to the manufacturer.

It may be that when applying adhesive to the bottom surface of the tape 30, that it is only at, or along portions of, the first portions 50. It may also be that the entire bottom of the tape 30 is adhesive (somewhat like masking or other tapes). It may be that portions of the second portion 52 have adhesive as well for at least some embodiments. Release paper 55 may be utilized with some embodiments.

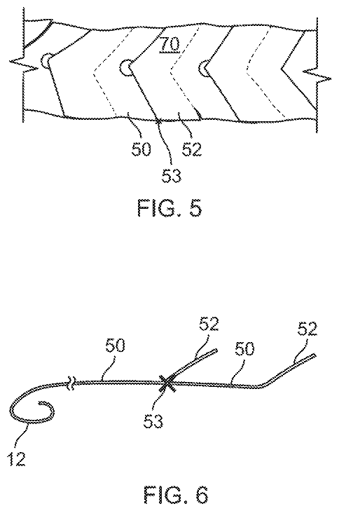

FIGS. 5-8 show other embodiments of rolls 12 of tape product 10. In these embodiments, it may be that adjacent first segments 50 meet at perforation 53 which could be along fifth and sixth angled segments 62, 64. Meanwhile the second portions 52 could extend above the adjacent first section 50 as shown in FIG. 6. It may also be possible to provide a construction where the second portions 52 extend below the adjacent first sections 50, somewhat similar to the embodiment of FIG. 8. Meanwhile, the embodiment of FIG. 8 is constructed whereby the adhesive surface 54 of first portion 50 utilizes an adjacent first portion 50 or possibly part of second portion 52 as a release paper so that successive units are effectively sequentially stacked and then rolled on a roll 12. With these type embodiments, it is not critical that the second portions have third angled segments 34 and fourth angled segments 36 which cooperate with the first and second angled segments 20, 22 to nest as provided with the embodiment of FIGS. 1-4, but they certainly could. With such a construction, it may not be necessary that adjacent marker units 14, 16 are perforatedly connected together.

Still other embodiments may have no second portion 52, or second portions 52 that are very narrow, so that it appears that first portion 50 connects to first potion 50 to first portion 50 with chevron shaped marker (or other shapes).

In use, one marker unit 14, 16 is removed from the others and applied as desired, such as to mark direction of flow, whether it be traffic, fluid or other flow. Other uses include marking issues to address such as paint or sheetrock imperfections. A particular user may utilize one color for one purpose and another color for another (blue for paint, yellow for sheetrock, etc.). Thus, a contractor, or other party, could walk through an almost complete construction and identify issues for a punch out person to address before a final walk-through inspection by a purchaser, etc. Other parties could use in similar or dissimilar ways. Teachers could use to assist in grading tests. Lawyers could use to identify where to sign a document. The applicant has not even begun to identify all of the potential uses of marker units 14, 16, when separated from the roll 12, but is very excited about the prospects.

FIG. 5 may also be viewed as a bottom plan view, of the first embodiment of the arrow tape, or tape product 10, showing the design and method, of applying chevron shaped pieces or marker units 14, 16, possibly spaced evenly, to the underside of the roll 12 of adhesive tape product 10.

These pieces of tape, or tape marker units 14, 16 on the underside 70, gives the tape marker units 14, 16, their distinctly placed non-adhesive backing portions, for the ease of removal, of the individual pieces or tape marker units 14, 16 from the roll 12 and later, the ease of removal from a surface, to where they are being applied, somewhat akin to adhesive notes used in office environments.

A method of doubling the thickness of tape marker units 14, 16 at the, on the tab or first surface 54 that will be grabbed by a user's fingers, may greatly increase the success that each marker unit 14, 16 will separate from the roll 12, perhaps only on an arrow shaped perforated line, or perforations 40, 42, 44, 46, etc. adjacent to it.

The adhesive face, or first surface 54, of chevron shaped tape, or marker units 14, 16, applied to underside of adhesive face, of the main part of the roll 12 of tape 40, may make up approximately one half, of each individual marker unit 14, 16 of tape 40, as it is removed from the roll 12 and used.

The lengths 58 and 60 of the underside applied pieces of chevron shaped tape, or arrow tape units 14, 16, can be varied on different rolls 12, to accommodate varied purposes, as needed. The shape of the marker units 14, 16, applied to the underside of the roll 12, can also be varied, to accommodate a custom design, for varied purposes, however, for many embodiments, the arrow or chevron shape is preferred.

Applying these uniquely shaped and spaced pieces or marker units 14, 16, of the tape 40, to the underside of the roll 12 of adhesive tape 40, or to form a tape 40, is believed exclusive to the utility and design of many embodiments of this invention, which this patent application is intending to protect.

A second method of providing a non-adhesive surface or second surface 56 portions, to potentially half of the underside, trailing edge, of each single piece of marker units 14, 16, is to omit the adhesive, on the underside of the adhesive tape, possibly in the arrow shaped pattern, during the manufacturing process. Perforations 40, 42, 44, 46, etc. may still be provided along leading edges of each piece of the marker units 14, 16.

The tape material, used to manufacture the tape 40, may be varied, to accommodate the user, according to a specific surface and/or if there is a specific environmental requirement of the product. For instance, environments may include moist or dry and dusty environments. The length of time the marker units 14, 16 are intended to be applied in a situation may also be a factor, such as when a longer period of time is contemplated, might affect the adhesive utilized or material integrity of much of the tape 40. Some embodiments may contemplate a situation where the tape 40, has a possible use underwater. Higher or lower than normal temperatures may be present and addressed with these or still other embodiments. This patent makes no guarantees, that various embodiments will work in some of these unusual conditions, however, the tape manufacturer, may develop new materials and adhesives, to achieve these new goals, and/or employ existing materials, adhesives and technology to achieve many of the objectives and effects of various embodiments discussed herein.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed is:

1. A roll of marker units comprising:
adjacently connected marker units wound to form a roll, said marker units having opposing side edges defining a width, an adhesive surface, and first and second portions, said first portion having first and second segments extending from the opposing side edges toward a point;
said second portion having third and fourth segments meeting at an internal corner;
said first and third segments of adjacent marker units initially contacting one another; and
said second and fourth segments of adjacent marker units initially contacting one another.

2. The roll of claim 1 wherein a first surface of a bottom of the first portion has the adhesive surface.

3. The roll of claim 2 wherein a second surface of a bottom of the second portion has the adhesive surface.

4. The roll of claim 2 wherein all of the bottoms of the first and second portions have the adhesive surface.

5. The roll of claim 1 wherein the first and second portions are similarly shaped.

6. The roll of claim 1 wherein the first and second angled segments meet at a point at a 90 degree angle.

7. The roll of claim 1 wherein the first and second angled segments are linear from the opposing side edges to the point.

8. The roll of claim 1 wherein the first and third segments are perforatedly connected together.

9. The roll of claim 8 wherein the second and fourth are perforatedly connected together.

10. The roll of claim 1 wherein a side edge length of the first portion is equal to a side edge length of the second portion for the marker units.

11. A roll of marker units comprising:
adjacent similarly constructed marker units wound about a roll, said marker units having side edges defining a width and first and second portions, said first portion having first and second segments extending from the opposing side edges to a point;
said second portion having third and fourth angled segments meeting at an internal corner;
said adjacent marking units initially contacting one another; and said first portion having a bottom surface with an adhesive portion, said adjacent marker units separated from one another upon pulling a portion of a first marker unit thereby dislodging the first marker unit from the roll along the first and second segments.

12. The roll of claim 11 wherein said first and third segments of adjacent marker units initially contacting one another; and said second and fourth segments of adjacent marker units initially contacting one another.

13. The roll of claim 11 wherein the first portion of the first marker unit contacts a first portion of an adjacent marker unit.

14. The roll of claim 13 wherein the second portion the adjacent marker unit extends one of above and below the first portion of the first marker unit.

15. The roll of claim 13 wherein the marker units are retained to a release paper.

16. The roll of claim 13 wherein the first marker unit is perforatedly connected to the adjacent marker unit.

17. The roll of claim 13 wherein the second portion has an adhesive portion thereon.

18. The roll of claim 11 wherein a side edge length of the first portion is equal to a side edge length of the second portion for the marker units.

19. The roll of claim 11 wherein the first and second angled segments are linear from the opposing side edges to the point.

20. The roll of claim 19 wherein the first and second angled segments meet at a point at a 90 degree angle.
